(19) United States
(12) Patent Application Publication
(10) Pub. No.: US 2002/0051489 A1
(43) Pub. Date: May 2, 2002

(54) Image matching method, and image processing apparatus and method using the same

(76) Inventors: Kozo Akiyoshi, Tokyo (JP); Nobuo Akiyoshi, Tokyo (JP)

Correspondence Address: Dowell & Dowell, P.C., 1215 Jefferson Davis Highway, Suite 309, Arlington, VA, 22202, US

(21) Appl. No.: 09/983,949

(22) Filed: Oct. 26, 2001

(30) Foreign Application Priority Data
Oct. 30, 2000 (JP) 2000-330297
May 22, 2001 (JP) 2001-152262

(51) Int. Cl. H04B 1/66

(52) U.S. Cl. 375/240

(57) ABSTRACT

An image matching method for processing a sequence of image frames. Matching between a pair of adjacent image frames, such as a pair comprised of the first and the second image frames, a pair of the second and the third image frames, . . . , and a pair of the (n−1)-th and the end (n-th) image frames, is sequentially processed. The matching generates a corresponding point file for each of the image frame pairs, which contains information related to corresponding points between image frame pairs. The resulting n−1 corresponding point files are then integrated into a single corresponding point file for a pair comprised of the first and the n-th image frames. The first and the n-th image frames are referred to as “key frames” and are stored or transmitted together with the single corresponding point file, while the intermediate image frames (the second to (n−1)-th image frames) may be discarded.

### BACKGROUND OF THE INVENTION

1. Field of the Invention

The present invention relates to an image compression technique. The present invention particularly relates to an image matching method for matching between image frames and compressing image data, and an image processing method and an image processing apparatus using the image matching method.

2. Description of the Related Art

Digital image processing techniques have been rapidly developed and it is now common for users to digitally record a lengthy moving picture for later replay. For instance, a moving picture captured by a digital camera can be input to a computer and transmitted as an attachment to an electronic mail. The captured moving picture can also be used for 3-D CG modeling, rendering and animation. As the use of digitally recorded moving pictures has become wide spread, the demand for high quality moving pictures has increased, as evidenced by the increased competition in the production of high density CCD and the development of high-speed image capturing processes.

In order to improve the quality of a moving picture, both the number of pixels and the number of image frames must be increased, resulting in the amount of digital image data becoming increasingly large. The digital image data are often recorded in a small memory card attached to a handheld digital camera, or stored on a computer hard disc, or transmitted by electronic mail or other means via the Internet. In such cases, it is difficult to handle a large amount of image data and it is easy to exceed the capacity of the storage media or the communication bandwidth. Therefore, image data compression has undoubtedly become a key technology in both a technical and a practical sense.

In the medical field, imaging technologies, such as CT and MRI, for capturing cross-sectional pictures of an affected area of a human body are widely used to improve the quality of medical examination. A large number of cross-sectional pictures need to be captured around the affected area, because it is important to have the most information and high quality of images for medical examination. A technology for compressing a sequence of pictures of this type is required by medical institutions in order to cope with storing large amounts of medical examination data.

### SUMMARY OF THE INVENTION

The present invention has been made in view of the above-mentioned situation, and an object thereof is to provide a technology by which a moving picture is encoded. Another object of the present invention is to provide an image processing technology by which a moving picture or any sequence of images, can be efficiently encoded and an image compression ratio can be improved.

According to one aspect of the present invention, an image matching method for processing a sequence of image frames is provided. The image matching method comprises: matching between two adjacent image frames such as a pair comprised of a first image frame and a second image frame, a pair comprised of the second image frame and a third image frame, . . . , and a pair comprised of an (n−1)-th image frame and an end (n-th) image frame; generating a corresponding point file for each of the image frame pairs, which contains information related to corresponding points between the image frame pair; and integrating the generated n−1 corresponding point files into a single corresponding point file for a pair of the first image frame and the end (n-th) image frame.

The corresponding point file describes the correspondence between the image frames. For instance, the corresponding point file contains a pair of the coordinates of corresponding points from each frame. In the above and in the following a corresponding point refers to a point or region of one image frame that corresponds to a pointer region of another image frame. Such a corresponding point may be a pixel or a dot of the image, a set of pixels or dots, a continuous part or a set of discontinuous parts, or a line such as a contour or an edge.

The image matching method may further comprise storing a function of a locus of at least one corresponding point which moves from the first image frame through the end (n-th) image frame. The locus can be obtained by tracking the corresponding points between the image frames and among pairs of image frames. The function describing the locus may be a parametric function such as a NURBS function or a Bézier function, which approximates the locus.

The image matching method may further comprise storing the first image frame and the end (n-th) image frame as key frames together with the single corresponding point file for the pair of the first image frame and the end (n-th) image frame. Image frames for which the matching fails may also be stored as key frames. For such mismatched key frames, another corresponding point file may be generated by the integration. In particular, the image matching method may include determining if a matching fails between an image pair and, if so, designating an earlier image frame of the matching-failed image pair as the end (n-th) image frame for subsequent processing and ending the matching of adjacent image frames, and may also include designating a later image frame of the matching-failed image pair as a new first image frame and restarting the matching of adjacent image frames.

The image matching method may further comprise intra-frame compression of the first image frame and the n-th image frame and storing the compressed image frames as key frames together with the single corresponding point file for the pair of the first image frame and the end (n-th) image frame. For the intra-frame compression, an image encoding method such as JPEG may be used. The corresponding point file may also be compressed using a dictionary based compression or Huffman encoding.

According to another aspect of the present invention, an image processing apparatus is provided. The image processing apparatus comprises an image input unit, a matching unit, a temporary storing unit, an integrating unit, and a key frame storing unit. The image input unit accepts an input of a sequence of image frames. The matching unit matches between each pair of adjacent image frames and generates a corresponding point file for each of the image frame pairs, which contains information related to the corresponding points between the image frame pair. This corresponding point file may also be referred to as an “inter-frame corresponding point file”. The temporary storing unit stores the generated corresponding point files. The integrating unit integrates the generated corresponding point files, in order of the sequence, into a single corresponding point file for a pair of key frames which are a start point and an end point of the integration. This single corresponding point file may also be referred to as “inter-key-frame corresponding point file”. The key frame storing unit stores the key frames and the single corresponding point file for the pair of the key frames in association. The image frames other than the key frames may also be called “intermediate frames”.

The image processing apparatus may further comprise a transmitting unit which transmits the key frames and the single corresponding point file for the pair of key frames to a user terminal, at which the sequence of the image frames ca be restored. The key frame storing unit may store the key frames and the inter-key-frame corresponding point file temporarily and discard these data after the transmission of the data.

The image processing apparatus may further comprise a tracking unit which tracks a locus of at least one corresponding point, which traverses or appears in the sequence of image frames, using the corresponding point files for each of the image frame pairs and generates the locus as function data. The key frame storing unit may store the function data in addition to the single corresponding point file for the pair of the key frames.

The tracking unit may sequentially track the corresponding points stored in the inter-frame corresponding point files and thereby obtain the locus of the corresponding points, which may move between the intermediate frames, and then convert the locus to a function. The tracking unit may also sequentially track the corresponding points stored in the inter-key-frame corresponding point files of a plurality of the key frames and thereby obtain the locus of the corresponding points which move between the plurality of key frames.

The integrating unit may terminate the integration when the pair of the adjacent image frames are not matched properly, leaving the former image frame of said pair as an end frame of the integration, and then resume a subsequent integration using the latter image frame of said pair as a new start frame of the subsequent integration. The key frame storing unit may also store such a mismatched image frame as a key frame.

According to still another aspect of the present invention, a computer program executable by a computer is provided. The computer program comprises the functions of matching between each of pairs of adjacent image frames among a sequence of image frames; generating a corresponding point file for each of the image frame pairs, which contains information related to corresponding points between each image frame pairs; integrating the generated corresponding point files, in order of the sequence, into a single corresponding point file for a pair of key frames which are a start frame and an end frame of the integration; and providing the key frames and the single corresponding point file for the pair of the key frames in association.

According to still another aspect of the present invention, an image processing method is provided. The image matching method comprises obtaining a plurality of corresponding point files, each of which describes corresponding points between a pair of frames, and generating a new corresponding point file using the plurality of the corresponding point files. This method may apply to corresponding point files between intermediate frames, key frames or otherwise. The new corresponding point file may be generated by integrating the plurality of corresponding point files in a temporal direction. As another way of integration, one corresponding point file may be generated using bilinear interpolation of the corresponding point files of frames captured from vertically different visual points, and the corresponding point files of frames captured from horizontally different visual points.

The image matching method may further comprise generating an intermediate frame between the frames by interpolation using the generated new corresponding point file.

Moreover, any arbitrary combination of the above-mentioned structural components in the present invention is still effective as an embodiment when applied as a method, a system, a server, a terminal, and a computer program, and so forth.

This summary of the invention does not necessarily describe all necessary features such that the invention may also be a sub-combination of the described features.

### BRIEF DESCRIPTION OF THE DRAWINGS

FIG. 1 is a block diagram of an image processing system according to an embodiment of the present invention.

FIG. 2 illustrates how corresponding points between two adjacent image frames are integrated sequentially.

FIG. 3 is a flow chart of a matching procedure for integrating corresponding point files of two adjacent frames into a single corresponding point file between two key frames.

FIG. 4 illustrates a data structure of image data wherein key frame data and inter-key-frame corresponding point data are associated.

FIG. 5 is a flow chart of a procedure for decoding the image data.

FIGS. 6A and 6B demonstrate a locus and a locus function respectively.

FIG. 7 illustrates a structure of a locus function file which associates the corresponding point data of the key frames and the locus function data.

### DETAILED DESCRIPTION OF THE INVENTION

The invention will now be described on the basis of the preferred embodiments, which are not intended to limit the scope of the present invention, but exemplify the invention. Each of the features and the combinations thereof described in the embodiments are not necessarily essential to the invention.

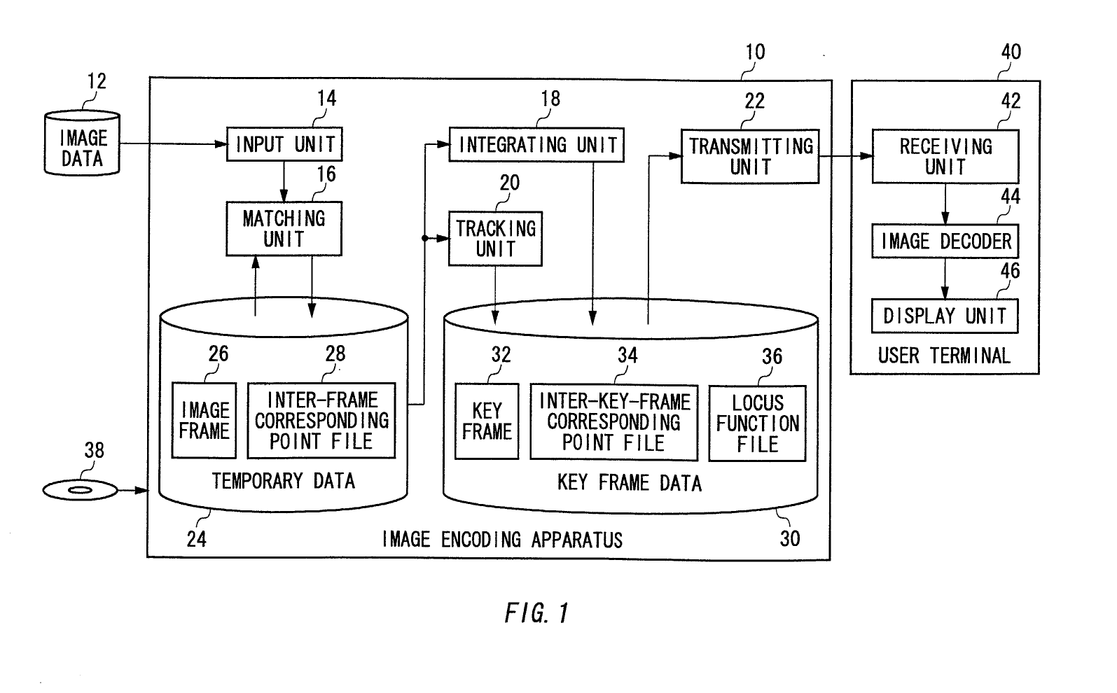

FIG. 1 is a block diagram of an image processing system according to an embodiment of the present invention. An image encoding apparatus 10 and a user terminal 40 communicate with each other via, for example, the Internet, which is not shown in the figure. The image encoding apparatus 10 includes an input unit 14, a matching unit 16, an integrating unit 18, a tracking unit 20, a transmitting unit 22, a temporary data storage 24, and a key frame data storage 30. The user terminal 40 includes a receiving unit 42, an image decoder 44, and a display unit 46. The image encoding apparatus 10 may have normal computer functions and the structure of the apparatus 10 may be implemented with a CPU, memory and a program with an image processing function loaded in the memory. In FIG. 1, however, the blocks are not divided in terms of hardware and/or software component, but in terms of function. A person skilled in the art would understand that various combinations of hardware and software components can accomplish the functions of these blocks. The functions of the blocks may be stored as software in a recording medium 38. The software may be installed on to a hard disc and then loaded in a memory to be executed by a CPU.

The input unit 14 of the image encoding apparatus 10 reads a sequence of image frames from, for example, an image data storage 12 and stores the data temporarily as image frame data 26 in the temporary data storage 24. The image data storage 12 may be provided in the image encoding apparatus 10 or may be provided separately in any other servers that are connected to the image encoding apparatus 10 via any communication means. The matching unit 16 obtains the image frame data 26 from the temporary data storage 24 and sequentially calculates matching for every pair of adjacent image frames in the image frame sequence to obtain corresponding points between adjacent image frame pairs. The matching unit 16 then stores a set of inter-frame corresponding point files 28, each of which describes the corresponding points between the two adjacent image frames, in the temporary data storage 24.

For convenience, one image frame of the image frame sequence is called a start frame and another image frame, which is a predetermined number of frames after the start frame in the sequence, an end frame. The integrating unit 18 refers to the inter-frame corresponding point files 28 stored in the temporary data storage 24 and integrates the corresponding points of all intermediate frames between the start frame and the end frame in order of the sequence. Thus the integrating unit 18 obtains corresponding points between the start frame and the end frame. The start frame and the end frame are called “key frames”. The integrating unit 18 then stores the key frame data 32 and an inter-key-frame corresponding point file 34, which describes the corresponding points between the key frames, in association in the key frame data storage 30.

The tracking unit 20 tracks the corresponding points using the inter-frame corresponding point files 28 and thereby obtains a locus of the corresponding points in the image frame sequence as a parametric function such as a NURBS function or a Bézier function. The tracking unit 20 then stores the obtained locus data as a locus function file 36 in the key frame data storage 30. The transmitting unit 22 may then transmit the key frame data 32 and the inter-key-frame corresponding point file 34 to the user terminal 40. The transmitting unit 22 may also transmit the locus function file 36 to the user terminal 40.

The receiving unit 42 of the user terminal 40 receives the key frame data 32, and the inter-key-frame corresponding point file 34 or the locus function file 36. The image decoder 44 decodes intermediate frames from the key frame data 32 using the inter-key-frame corresponding point file 34 or the locus function file 36. The display unit 46 restores and displays the original image sequence using the key frames and the decoded intermediate frames.

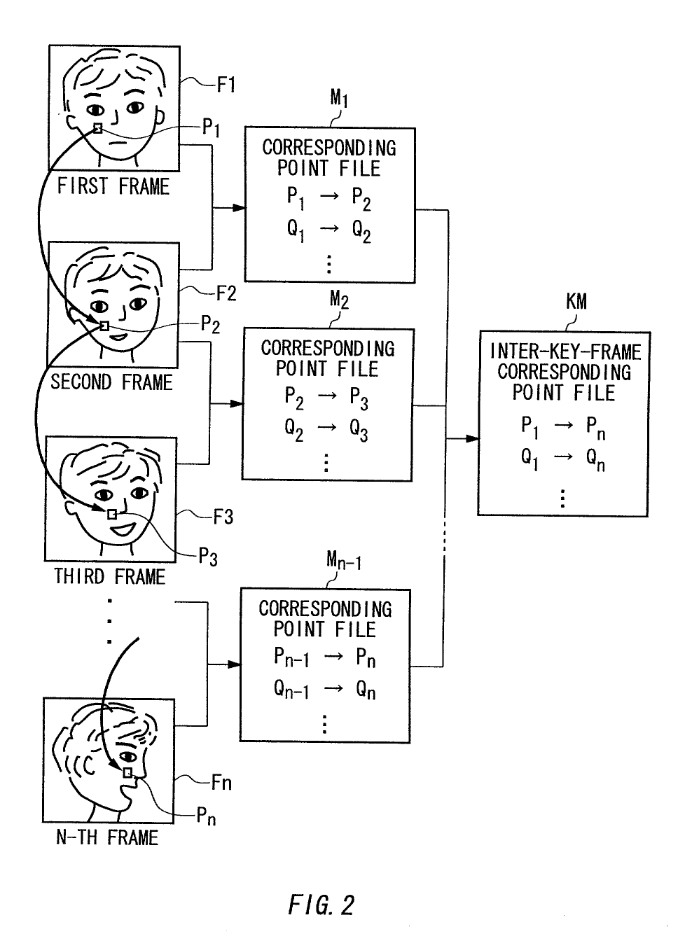

FIG. 2 illustrates how the corresponding points are integrated sequentially. In FIG. 2 corresponding image points P1, P2, P3, . . . , Pn are shown in a sequence of image frames F1, F2, F3, . . . , Fn. The matching unit 16 calculates matching of the pairs of the image frames F1 and F2, F2 and F3, and so on. This matching process generally obtains the correspondence of image points between pairs of image frames. As described n the summary section above, such correspondence may be between points, two particular regions or areas, or two lines such as contours or edges of the image frames, but they are all referred to herein as points or corresponding points. A multi-resolution critical point filter technique and an image matching technique using the filter technique, both of which are disclosed in Japanese Patent No. 2927350 by the applicant of the present invention, may be adopted as the matching process. Other matching techniques such as methods utilizing color information, block matching methods utilizing brightness and location information, methods utilizing extracted contours or edges, and any combination of these methods may also be employed in the matching process.

The matching unit 16 stores the corresponding points obtained in the matching calculation for the image frame pairs F1 and F2, F2 and F3, . . . , and Fn-1 and Fn, in the inter-frame corresponding point files M1, M2, . . . , Mn-1, respectively. The integrating unit 18 then refers to these corresponding point files M1, M2, . . . , Mn-1 sequentially and thereby obtains corresponding points between the image frame F1 and Fn, and then stores the obtained corresponding points in an inter-key-frame corresponding point file KM. For instance, the point P1 in the first image frame F1 corresponds to the point P2 in the second image frame F2, and further corresponds to the point P3 in the third image frame F3. Similarly, a point Q1 (not shown) in the first image frame F1 may correspond with a point Q2 (not shown) in the second image frame F2, and so on. In the integrating unit 18, these corresponding points are sequentially integrated or followed and it is thus detected that the point P1 in the first image frame F1 corresponds to the point Pn in the n-th image frame Fn.

The corresponding points of two non-adjacent image frames, such as F1 and Fn, may not be properly obtained if the matching is calculated directly between the two non-adjacent frames, because of the discontinuity between these two image frames. However, when the corresponding points between the adjacent image frames are sequentially integrated, the precise correspondence between the non-adjacent frames can be obtained.

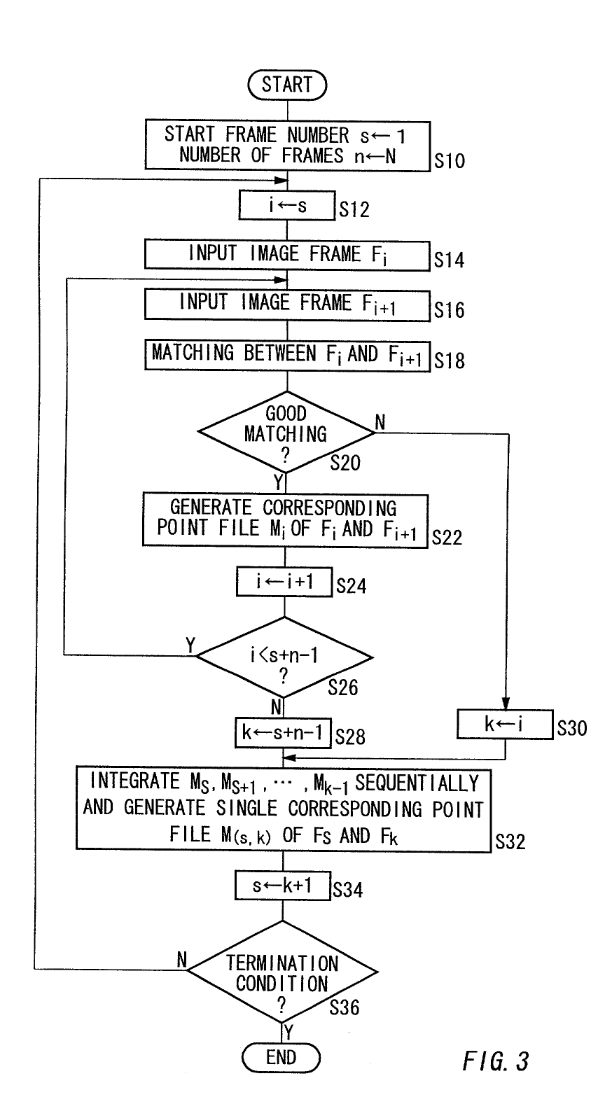

FIG. 3 is a flow chart of the matching procedure for generating corresponding points between adjacent frame pairs and the integrating procedure for obtaining the corresponding points between the key frames.

The matching procedure progresses as follows. First, set a start frame number s to 1 and set the number of the frames to be matched and integrated n to N (S10) where N may be the total number of frames in the sequence or predetermined number of frames for processing. Assign the start frame number s to the index variable i which indicates the current frame number (S12). Input the image frame Fi (S14). Input the image frame Fi+1 (S16). The matching unit 16 then calculate the matching between the image frames Fi and Fi+1 (S18) and judges whether the matching is good or bad (S20). If the matching is good (Y of S20), the matching unit 16 generates a corresponding point file Mi of the image frames Fi and Fi+1 and stores the corresponding input file in the temporary data storage 24 (S22). Increase the variable i by 1 (S24) and check whether the variable i is smaller than s+n−1 (S26). If the variable i is smaller than s+n−1 (Y of S26), go back to S16. If the variable i equals s+n−1 (N of S26), assign the value s+n−1 to a variable k (S28).

The integrating unit 18 reads the inter-frame corresponding point files Ms, Ms+1, . . . , Mk−1 generated by the matching unit 16 from the temporary data storage 24 and sequentially integrates these files into a single inter-key-frame corresponding point file M(s,k) for the image frames Fs and Fk (S32). The integrating unit 18 stores the image frames Fs and Fk as key frame data 32 and the single inter-key-frame corresponding point file M(s,k) as the inter-key-frame corresponding point file 34. Next, assign the value k+1 to the start frame number s (S34). Check the termination condition, for instance, whether the start frame number s is greater than a predefined value or not (S36). If the condition is not satisfied (N of S36), go back to S12, and if the condition is satisfied (Y of S36), terminate the procedure.

If the matching at S20 is bad (N of S20), assign the value of the variable i to the variable k (S30) and go to S32. A good matching in S20 means that the image frames from Fs to Fi constitute a continuous moving picture. A bad matching in S20 means that the image frame Fi+1 is sufficiently different from the previous image frame, Fi to cause a discontinuity, for instance, because of a scene change. One of the skill in the art will understand there are a number of ways to identify a bad matching. In the case of bad matching, the image frames Fs and Fi become a pair of key frames and the corresponding point files of the intervening image frames from Fs to Fi are integrated into a single corresponding point file. The image frame Fi+1 then becomes a new start frame and a new iteration of the matching and integrating for the image frames from Fi+1 onward begins.

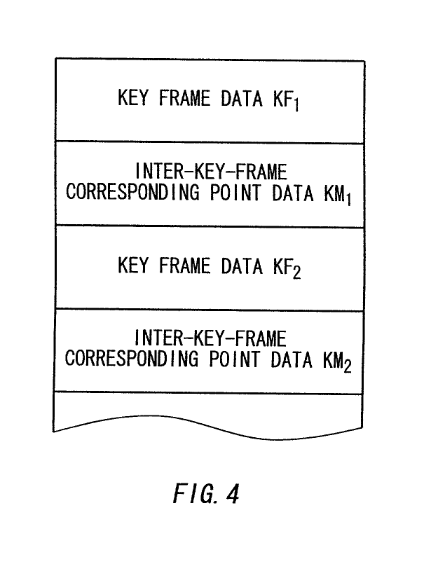

FIG. 4 illustrates an example data structure wherein key frame data and inter-key-frame corresponding point files are associated. In this example, the inter-key-frame corresponding point data file KM1 is inserted between the key frame data KF1 and the key frame data KF2. Similarly, the inter-key-frame corresponding point data KM2 is inserted after the key frame data KF2. Thus, compressed image data are formed with alternating key frame data and inter-key-frame corresponding point data in the same order of the key frames. The key frame data storage 30 may store the key frame data 32 and the inter-key-frame corresponding point file 34 in this form or the transmitting unit 22 may convert the image data to this form when the image data is transmitted to the user terminal 40. Furthermore, the key frame data may also be compressed by any appropriate compression method such as JPEG and the inter-key-frame corresponding point data may be compressed by any appropriate compression method, such as document compression.

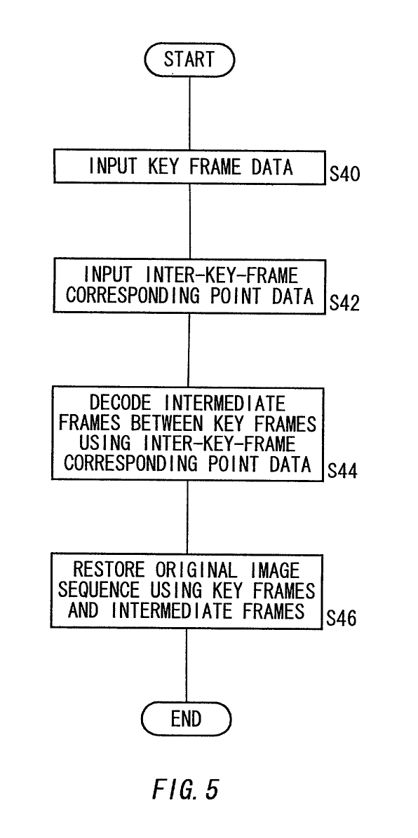

FIG. 5 is a flow chart of a procedure for decoding the compressed image data. The receiving unit 42 of the user terminal 40 receives the compressed image data from the transmitting unit 22 of the image encoding apparatus 10. The receiving unit 42 then extracts the key frame data and the inter-key-frame corresponding point data from the compressed image data (S40, S42). The image decoder 44 decodes, or interpolates, intermediate frames between the key frames based on the inter-key-frame corresponding point data (S44). The display unit 46 restores and displays the original image sequence using the key frames and the decoded intermediate frames (S46).

In the above procedure of FIG. 5, the compressed image data received by the user terminal 40 does not include information on the corresponding points of the intermediate frames (that is, the locus function file 36) but includes only the key frame data and inter-key-frame corresponding point data. However, the locus function file 36 may also be provided to the user terminal 40 in order to improve the continuity of the restored moving picture.

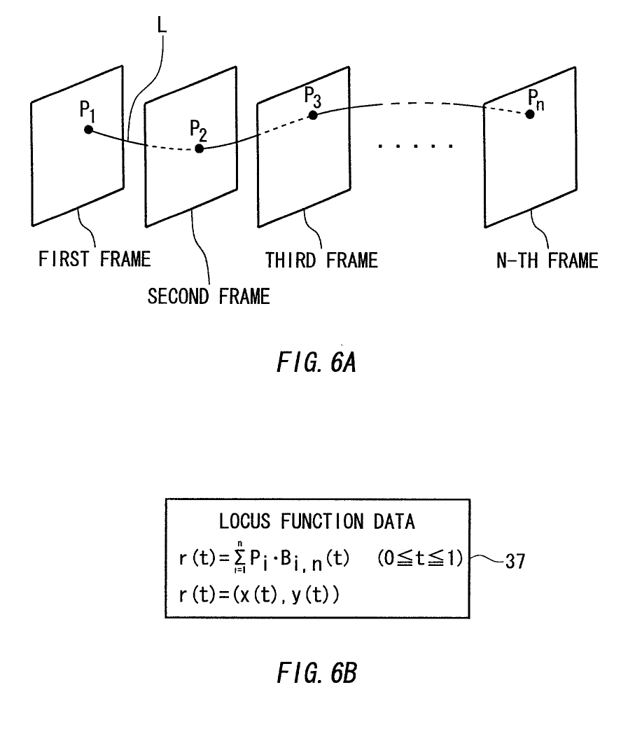

FIGS. 6A and 6B demonstrate a locus and locus function data, respectively. As shown in FIG. 6A, the point P1 in the first frame corresponds to the point P2 in the second frame, to the point P3 in the third frame, . . . , and the point Pn in the n-th frame. A function L can be defined such that it passes through the points P1 and Pn and approximates the locus of the intermediate points P2 to Pn−1. The function L may be any appropriate function, for example, a parametric function such as a NURBS function or a Bézier function. The tracking unit refers to the inter-frame corresponding point files 28 and applies an appropriate parametric function to the corresponding points and thereby obtains the locus function data 37 as shown in FIG. 6B. When the locus of the corresponding points is expressed as a function with an appropriate dimension n, the amount of data required to describe the locus can be smaller than that of the original corresponding point files 28. Furthermore, the locus function can be used to calculate corresponding points for non-existent intermediate image frames, so that the number of restored intermediate frames can be varied, for example, to increase the number of frames so that continuity of the restored image sequence can be enhanced.

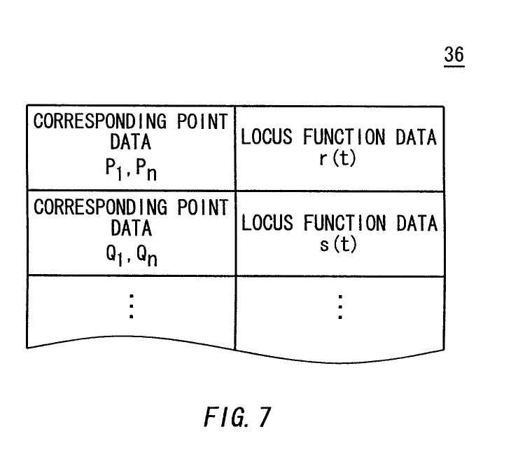

FIG. 7 illustrates a structure of a locus function file 36 in which the inter-key-frame corresponding point data and the locus function data are combined together. In particular, in the locus function file 36 of FIG. 7, the corresponding points of the key frames and the locus function that approximates the locus of the corresponding points of the intermediate frames are also associated. In this case, because the locus function file 36 includes both the inter-key-frame corresponding point data and the locus function data, the user terminal 40 can decode intermediate frames using only the key frame data 32 and the locus function file 36 in order to restore the original image frame sequence.

In the present embodiment of the image encoding apparatus using the image matching method, the intermediate frames may be discarded after the inter-key-frame corresponding point file is generated and the image sequence can be efficiently encoded and compressed using only the key frames and the inter-key-frame corresponding point file. The correspondence between the key frames obtained by sequentially matching the intermediate frames of the image frame sequence is more precise than that obtained from direct matching between the key frames themselves.

Although the present invention has been described by way of exemplary embodiments, it should be understood that those skilled in the art might make many changes and substitutions without departing from the spirit and the scope of the present invention as defined by the appended claims.

For example, although the image matching process is described in the context of moving pictures herein, the present invention can be applied to other types of image sequences, such as a set of still pictures of a particular object or scene captured from different vantage points, or a set of cross sectional images of an affected area on a human body captured by a CT scanner for medical purposes. As long as these images evolve in sequence in space, they form an image frame sequence just like a moving picture which evolves over time. The corresponding points between the adjacent image frames in a spatially evolving image sequence can also be integrated and tracked sequentially and the corresponding points between non-adjacent image frames can be similarly extracted as in an image sequence evolving in time.

What is claimed is:

1. An image matching method for processing a sequence of image frames, comprising:
matching between two adjacent image frames in the sequence of image frames, such as a pair comprised of a first image frame and a second image frame, a pair comprised of the second image frame and a third image frame, . . . , and a pair comprised of an (n−1)-th image frame and an end (n-th) image frame;
generating a corresponding point file for each image frame pair, which contains information related to corresponding points between the image frame pair; and
integrating the generated n−1 corresponding point files into a single corresponding point file for a pair comprised of the first image frame and the end (n-th) image frame.

2. The method of claim 1, further comprising storing a function of a locus of at least one corresponding point that is in each image frame from the first image frame through the end (n-th) image frame.

3. The method of claim 1, further comprising storing the first image frame and the end (n-th) image frame as key frames together with the single corresponding point file for the pair of the first image frame and the n-th image frame.

4. The method of claim 3, wherein an image frame for which the matching fails is also stored as a key frame.

5. The method of claim 1, further comprising:
determining if a matching fails between an image pair and, if so, designating an earlier image frame of the matching-failed image pair as the end (n-th) image frame for subsequent processing and ending the matching of adjacent image frames.

6. The method of claim 5, further comprising:
designating a later image frame of the matching-failed image pair as a new first image frame and restarting the matching of adjacent image frames.

7. The method of claim 1, further comprising intra-frame compression of the first image frame and the end (n-th) image frame and storing the compressed image frames as key frames together with the single corresponding point file for the pair of the first image frame and the end (n-th) image frame.

8. An image processing apparatus comprising:
an image input unit which accepts an input of a sequence of image frames;
a matching unit which matches between each pair of adjacent image frames in the sequence, and generates a corresponding point file for each of the image frame pairs, which contains information related to corresponding points between the image frame pair;
a temporary storing unit which stores the generated corresponding point files;
an integrating unit which integrates the generated corresponding point files in order of the sequence into a single corresponding point file for a pair of key frames which are a start frame and an end frame of the integration; and
a key frame storing unit which stores the key frames and the single corresponding point file for the pair of the key frames in association.

9. The apparatus of claim 8, further comprising a transmitting unit which transmits the key frames and the single corresponding point file for the pair of key frames to a user terminal at which the sequence of the image frames can be restored.

10. The apparatus of claim 8, further comprising a tracking unit which tracks a locus of at least one corresponding point which traverses the sequence of image frames from the start frame to the end frame, using the corresponding point files for each of the image frames pairs and generates function data describing the locus, wherein the key frame storing unit stores the function data in addition to the single corresponding point file for the pair of the key frames.

11. The apparatus of claim 8, wherein the integrating unit terminates the integration when a pair of adjacent image frames are not matched properly, leaving a former image frame of said pair as an end frame of the integration, and then resumes a subsequent integration using a latter image frame of said pair as a new start frame of the subsequent integration.

12. A computer program executable by a computer, the program comprising the functions of:
matching between each of pairs of adjacent image frames among a sequence of image frames;
generating a corresponding point file for each of the image frame pairs, which contains information related to corresponding points between each image frame pair;
integrating the generated corresponding point files, in order of the sequence, into a single corresponding point file for a pair of key frames which are a start frame and an end frame of the integration; and
providing the key frames and the single corresponding point file for the pair of the key frames in association.

13. An image processing method comprising:
obtaining a plurality of corresponding point files, each of which describes corresponding points between a pair of frames; and
generating a new corresponding point file using the plurality of the corresponding point files.

14. The method of claim 13, wherein:
the new corresponding point file is generated by integrating the plurality of the corresponding point files in a temporal direction.

15. The method of claim 13, further comprising generating an intermediate frame between the frames by interpolation using the generated new corresponding point file.

16. A computer program executable by a computer, the program comprising the functions of:
obtaining a plurality of corresponding point files each of which describes corresponding points between a pair of frames; and
generating a new corresponding point file using the plurality of the corresponding point files.
